(19) United States
(12) Patent Application Publication
(10) Pub. No.: US 2017/0037901 A1
(43) Pub. Date: Feb. 9, 2017

(54) LEAD-FREE CUNI2SI SLIDING BEARING MATERIAL WITH THE ADDITION OF A METAL HAVING A CHIP-BREAKING EFFECT

(71) Applicant: FEDERAL-MOGUL WIESBADEN GMBH, WIESBADEN (DE)

(72) Inventors: GERD ANDLER, BAD SCHWALBACH (DE); HOLGER SCHMITT, PFUNGSTADT (DE); HORST GEBER, BINGEN AM RHEIN (DE)

(21) Appl. No.: 15/304,259

(22) PCT Filed: Apr. 16, 2015
(86) PCT No.: PCT/EP2015/058234

§ 371 Date: Oct. 14, 2016

(30) Foreign Application Priority Data
Apr. 16, 2014 (DE) 10 2014 207 331.6

(51) Int. Cl. F16C 33/12; C22C 9/06; B32B 15/01; C22C 9/10

(52) U.S. Cl. CPC F16C 33/122; C22C 9/10; C22C 9/06; B32B 15/015; F16C 2204/10

(57) ABSTRACT

The invention relates to a sliding bearing material with a matrix material which consists of 0.5-5 wt. % nickel, 0.25-2.5 wt. % silicon, <0.1 wt. % lead, impurities that result from the metallurgical smelting process, and the rest being copper, with optionally at least one hard material and optionally at least one solid lubricant, and which has at least one tellurium additive. The invention also relates to a sliding bearing composite material which has a carrier layer, a bearing metal layer and a sliding layer applied to said bearing metal layer, the bearing metal layer consisting of such a sliding bearing material, as well as to a sliding element or sliding bearing that consists of such a sliding bearing composite material.

This invention relates to a sliding bearing material with a matrix material which consists of 0.5-5 wt. % nickel, 0.25-2.5 wt. % silicon, <0.1 wt. % lead, with the rest being copper. The invention also relates to a sliding bearing composite material with a backing layer, a bearing metal layer and a sliding layer applied to said bearing metal layer, as well as a sliding element, namely a radial sliding bearing in the form of a bushing or a bearing shell.

Lead-free materials based on copper, nickel and silicon, hereinafter referred to as CuNiSi alloys, have been common knowledge for a long time and have also been used for a while as sliding bearing materials, particularly sliding bearing composite materials for bushings or bearing shells. The document WO 2006/120016 A1 is referred to as an example in which the material with the aforementioned composition is described.

Copper-nickel-silicon alloys can be processed both in casting and sintering, or applied to a backing layer using roll bonding. They are characterized by high ductility, basic strength and basic hardness. These parameters can be adjusted to the respective requirements across a wide range using thermomechanical processing, so that the materials reach the level of hardness, strength and seizure behaviour of the lead-bronze that needs to be replaced due to insufficient environmental compatibility. In fact, the materials are considerably less machinable than these for many reasons, including their high basic strength and hardness. Poor machinability results in a shorter tool life and accordingly quick deterioration in terms of machining precision and surface quality.

The German Copper institute systematically investigates, among other things, the machinability of copper materials and publishes the results in the so-called information print-outs. Below, the 18^{th} edition of the information print-out (i.18) from 2010 is referred to. Here, the machinability of copper materials is divided into three different major groups. Materials that are similar in terms of machinability are grouped together. Copper materials are primarily categorized based on the chip shape that is formed and the amount of wear on the tool.

Machining Group contains copper materials with very good machinability and covers lead-copper, tellurium-copper or sulphur-copper alloys with a homogenous or heterogeneous structure. During machining, short, discontinuous chips are formed. The wear on the tool is rated as low. Machining Group II contains materials that are moderately to easily machinable. Compared with materials in Machining Group I, machining these materials results in longer chips, generally medium-length, spiral-shaped chips. The wear on the tool when machining these kinds of materials is rated as “medium”. In Machining Group III, the materials that are most difficult to machine compared to Groups I and II are grouped together. When machining these materials, long, spiral-shaped, thread or ribbon chips are formed. The wear on the tool is high.

In order to make further differentiations regarding the machinability of the standard materials within these major groups, the data for which was obtained empirically, a machinability index is also established. For the materials in the first group, this is between 100 and 70; for those in the second group, it is between 60 and 40, and for those in the third group, it is between 30 and 20.

According to the information print-out i.18 from the German Copper Institute, CuNiSi alloys have a machinability index of between 20 and 40, depending on the material's composition and heat treatment, meaning that they would come under Machining Group II or Machining Group III.

A copper-based wrought alloy with 1.5 to 7.0 wt. % Ni, 0.3 to 2.3 wt. % Si and 0.02 to 1.0 wt. % S for electronic components is described in the document US 2013/0028784 A1.

The purpose of the invention is to provide a sliding bearing material of the aforementioned kind which has good tribological and mechanical properties similar to those of CuNiSi alloys that are already known, but with improved machinability and, due to a longer tool life, with greater machining precision and surface quality. Another purpose of the invention is to provide a material which, in contrast to materials that are already known, is even less susceptible to seizure, particularly when there is a lack of lubrication.

The purpose is fulfilled with the sliding bearing material according to patent claim 1.

The inventive sliding bearing material features a matrix material made from 0.5-5 wt. % nickel, 0.25-2.5 wt. % silicon, <0.1 wt. % lead, impurities that result from the metallurgical melting process, with the rest being copper, with optionally at least one hard material and optionally at least one solid lubricant, and which has at least one tellurium additive with the rest copper.

It was ascertained that by adding tellurium as a chip-breaking element, the chip shape and therefore the machinability of these matrix alloys were also improved. The addition of Te leads to a reduction in the material's elongation at break. Whilst CuNi2Si without these additions has an elongation at break of around 20%, this can be reduced to up to 2% by adding tellurium. The chips therefore do not form any long ribbon or continuous chips, but rather break into fine, needle-like fragments which, in contrast to long chips, do not hinder the machining of the material. It was particularly surprising to discover that the addition of tellurium also significantly reduces the sliding bearing material's susceptibility to seizure.

According to an advantageous embodiment, the additive is fully dispersed within the matrix material with a proportion of 0.01 to 2.0 wt. % in relation to the sliding bearing material. It is preferable for the additive to be dispersed fully with a proportion of 0.05 to 1.0 wt. %, and particularly preferable fully with a proportion of 0.1 to 0.3 wt. % within the matrix material.

The effect of the reduced elongation at break is only desirable up to a certain point, because if the elongation at break is too low, then it only allows for a limited amount of deformation of the CuNiSi material after casting, and this deformation ability is essential when manufacturing a bearing. Therefore, the elongation at break must never be below 1%, if the amount is above 2 wt. %, then this is no longer guaranteed, and essential properties of the matrix material, such as strength, deformation ability etc., could be affected. If the amounts are too low, i.e. below 0.01 wt. %, the chip-breaking effect does not manifest itself sufficiently. The chip-breaking effect is already very well pronounced with additive quantities of 0.1 to 0.3 wt. %, without the matrix material's properties being significantly worsened. This quantity range therefore appears to be a very good compromise.

The added tellurium is undissolved within the CuNiSi matrix and is therefore in a separate phase. This phase is predominantly found at the grain boundaries of the matrix material, where they cause cracks to be diverted in the matrix structure under heavy, localized, mechanical loads such as during machining, and therefore ultimately encourage the chip to break off under a continuous load. It is preferable for 90% of the measurable particle in the matrix material to have a maximum dimension of 30 μm, and even more preferable to have one of 15 μm, “Measurable” refers to all particles that have a minimum size of 500 nm. This minimum size only serves as an explicit “cut-off” point for detection and therefore for the purposes of unambiguity in the parameters.

If the additive forms particles of this size, then the additive is dispersed in the CuNiSi such a matrix in way, that it significantly increases the machinability of the sliding bearing material, whilst the other mechanical and tribological properties of the matrix materials are either influenced in a very small amount or not at all, or even, in the case of susceptibility to seizure, surprisingly positively influenced. This is due to the fact that a finer distribution of particles causes widespread disruption in the grain boundaries of the matrix structure, and therefore the chips break more easily. To prevent this leading to a significant loss in strength, the contents of the chip-breaking additive within the boundaries outlined above must be retained. However, if the particles are larger than 15 μm and can therefore only be found sporadically and locally throughout the structure with a proportion of 2 wt. % or less, there will be no sufficient chip-breaking effect in the whole material.

Following the dispersion of at least one additive within the matrix, the sliding bearing material has an advantageous machinability index of 100-70. With a machinability index of 100 to 70, the sliding bearing material is categorized into Machining Group I. It forms discontinuous chips during machining, which do not affect the machining of the material because they can be effectively removed from the machining area. This increases the surface quality, machining precision and reduces wear on the tool.

In another advantageous embodiment, on a sliding bearing material below the limit of a load and sliding speed of 800 MPa m/s, preferably below 850 MPa m/s, no adhesive wear occurs.

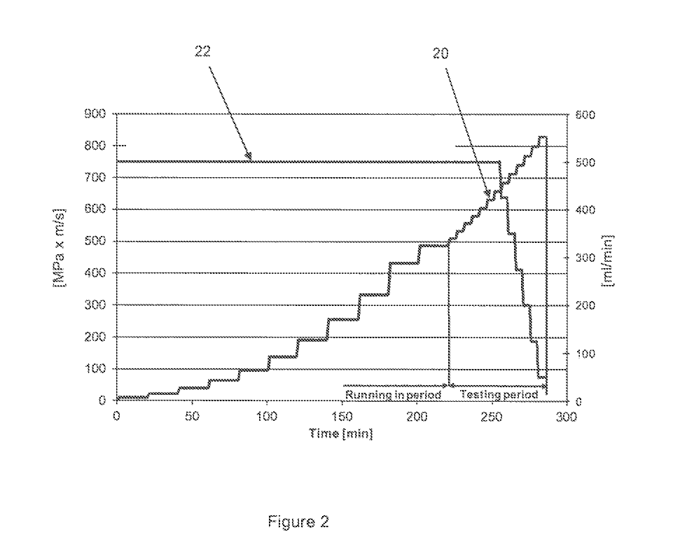

The maximum load and sliding speed measurement is recorded in a seizure test, as described below in FIG. 2, for example. The limit or maximum value of 800 MPa m/s, preferably 850 MPa m/s, is surprisingly significantly higher than for other known CuNiSi materials. The addition of tellurium within the aforementioned range therefore does not just have a chip-breaking effect, but also a wear-reducing or lubricating effect. In the case of the invented bearing material, damage to the material caused by seizure only occurs under very high loads and/or relative sliding partner speeds, so the sliding bearing material can withstand loads for longer with insufficient lubrication.

The sliding bearing material should preferably have a nickel to silicon weight ratio of between 2.5 and 5.

Such a weight ratio is advantageous for the formation of the nickel-silicon compounds that are responsible for good tribological properties. The sliding bearing's susceptibility to seizure is particularly improved by this, so the material combined with the addition of tellurium can exceed the properties of traditional lead-bronze materials.

The sliding bearing material should also preferably include at least one hard material selected from a group consisting of silicides, oxides, carbides and nitrides, in particular AlN, Al₂O₃, SO₂, TiO₂, ZrO₂, Mo₂C, MoSi₂, SiC, B₄C, Si₃N₄ and c-BN.

It is also advantageous if the sliding bearing material includes at least one solid lubricant selected from a group consisting of h-BN and graphite.

The siding bearing material described above can be used as a solid material in a sliding bearing element, such as a bushing or a bearing shell. A solid material means that the material has a sufficient level of strength and therefore supports itself. At the same time, the material takes on the role of a bearing metal.

The invention also includes a sliding bearing composite material with a backing layer, a bearing metal layer and a sliding layer applied to said bearing metal layer. The bearing metal layer consists of a sliding bearing material of the type described above.

Sliding bearing composite materials, particularly in the form of sliding bearing dements converted into bearing shells, are calibrated to their final dimension in the final working stage by drilling. As bearing shells must fundamentally be mass-produced, there is currently a need for optimizing this stage of machining. For example, several of the same bearing shells can be placed in a row and drilled in one working step. Further, a high cutting and feed speed is demanded. The tool life must be high so that as little time as possible is lost in changing the tool and the following setup procedure. Last but not least, wet machining must be ruled out because residue from coolants and lubricants would have to be laboriously removed from the bearing shell surface. Machinability is therefore currently the most important factor in this application.

The backing layer in the sliding bearing composite material preferably is a steel layer.

The so-called steel backing ensures the required press fit due to its stiffness, so the composition of the bearing material's structure can be adjusted regardless of strength requirements. The microstructure of the claimed copper alloys can therefore be designed in such a way that their strength and hardness, as well as their tribological properties, such as seizure behaviour, are similar to those of traditional lead-bronze materials. Overall, the scope of application for the sliding bearing composite material is significantly expanded. With steel backings, the composite materials also offer advantages due to their thermal expansion coefficient in situations where steel casing is used.

The aim of the manufacturing process described below is for the tellurium phase to be present in the end product, in a defined size which has proven to be beneficial in terms of seizure behaviour. There is also no need for a finishing ageing heat treatment, which is not used when as in this case the main focus is optimizing the sliding properties, but rather for improving strength or electrical conductivity.

According to an advantageous embodiment, the bearing metal layer is a sinter layer.

The sinter layer is applied to the steel backing in powder form. The additive can already be contained in the pre-alloyed matrix material and pulverized together with this, or it can be added as a separate powder to the sinter powder of the matrix material. If the CuNiSi matrix and the additive are in separate powder forms, these powders can be mixed with the appropriate weight distributions and then sintered on the backing layer. The sinter material that is applied to the steel backing is heated to a sinter temperature of between 800° C. and 1000° C. over a period of 10-30 minutes. Here, in the sinter process, an initial annealing process is integrated. Subsequent rolling procedures compact the bearing metal layer until its porosity reaches the desired level. At the same time, by rolling in combination with annealing, the desired material properties of the bearing metal can be adjusted, particularly its yield strength. The details of the sinter process are as follows: The sinter powder is applied to the steel backing in a defined thickness: then, the first sinter process takes place at a temperature of between 800° C. and 1000° C. Before the second sinter process is carried out at a similar temperature, the sinter layer is compacted using a rolling process during deformation of between 10-30%, and therefore condensed. One final round of rolling completes the process, which adjusts the bimetallic strip to the desired strength and thickness tolerance. In both sinter processes, the cooling conditions are controlled in such a way that the separate tellurium particles do not exceed maximum dimension of 30 μm, preferably of 15 μm.

According to an alternative embodiment, there is a roll cladding connection between the bearing metal layer and the carrier layer, if necessary via an intermediate layer.

First, the bearing metal is manufactured in the form of strip material, the intermediate layer is optionally pre-cladded and then the bearing metal is rolled out onto the backing layer (with or without the intermediate layer). Thereby, the bearing metal undergoes a deformation of 35-70%, which makes it necessary to then carry out subsequent thermomechanical treatment in order to adjust the mechanical properties of the bearing metal to the desired level. This includes an initial annealing of the composite at 550° C. to 700° C. for 2 to 5 hours, at least one initial rolling of the composite, whereby a deformation degree of 20 to 30% is achieved, at least one second annealing process at 500° C. 600° C. for more than 1 hour, if necessary a second rolling of the composite, whereby a deformation degree of max. 30% is achieved, with a subsequent third round of annealing at a temperature of >500° C. for at least 1 hour. The annealing temperature and the time for which it is kept at this temperature are selected in such a way that the tellurium phase forms within the aforementioned size range here as well. There is no ageing heat treatment, which is usually used to increase strength and electrical conductivity. As the third round of annealing described above is preceded by cold rolling, this annealing process causes the size of the tellurium phase to be adjusted, as well as causing a recrystallization of the matrix material.

For the intermediate layer, either copper or a copper alloy can be used, for example a copper-zinc alloy or a copper-tin alloy.

In another alternative embodiment, the bearing metal layer is a cast layer. The casting of the backing layer typically takes place at a temperature of 1000° C. to 1250° C. Here too, it is followed by thermomechanical treatment using roiling and annealing to achieve the desired material properties, in particular the tellurium size distribution and therefore an improved resistance to seizure. After casting on a steel strip, the composite material undergoes a homogenization procedure at a temperature of more than 650° C. for several hours (>4 h). There is a subsequent deformation of the composite of between 35 and 70% in several rolling passes, followed by another final annealing process which adjusts the size of the tellurium phase, as well as causing the matrix material to recrystallize. Here too, temperatures of above 500° C. are used for a period of more than 1 hour.

Along with the sliding bearing material and the sliding bearing composite material, the invention also includes a sliding element, in particular a sliding bearing which consists of a sliding bearing material of the type described above.

To manufacture the sliding bearing element, boards are slit and then separated from the solid or sliding bearing composite material, manufactured as described above, and the boards are transformed into sliding bearing elements (e.g. bearing shells or bushings) using known deformation processes. This is followed by a machining process to create the dimensional accuracy of the bearing bore and, if necessary, applying a sliding layer.

Other properties and features of the invented sliding bearing material are explained in the following drawings. These are:

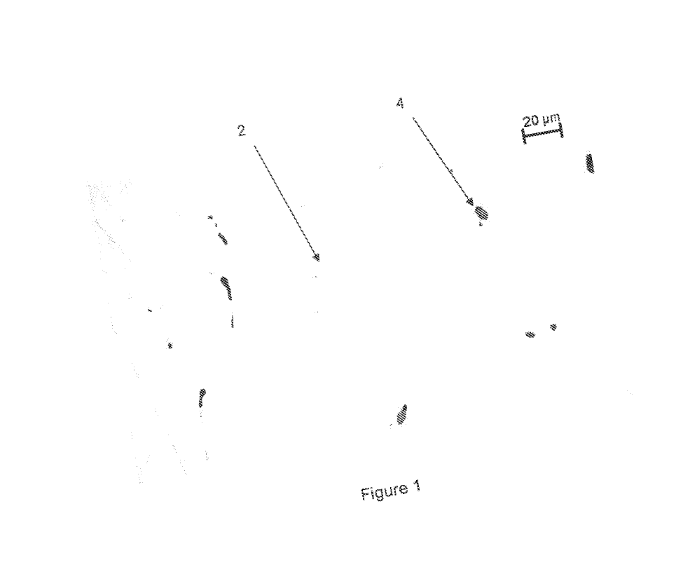

FIG. 1 a light microscope picture of the surface of the invented sliding bearing material,

FIG. 2 a diagram to illustrate a test program for determining wear on a sliding bearing, and

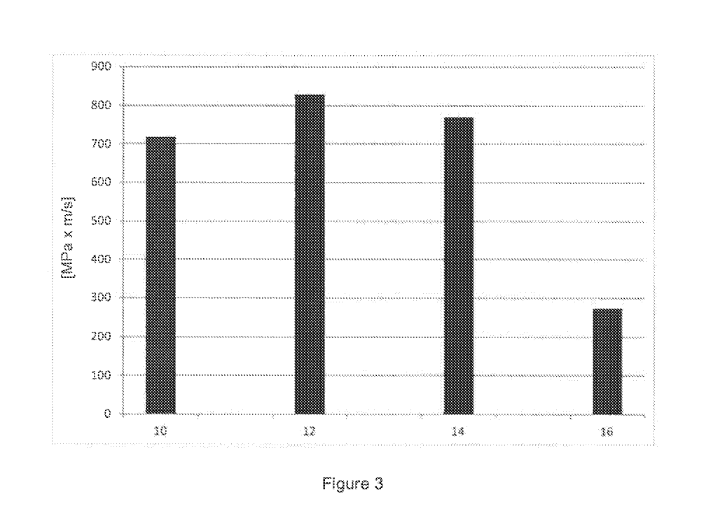

FIG. 3 a diagram of determined wear values of the invented and various other copper alloys.

FIG. 1 shows a light microscope picture of the cross-section of the invented sliding bearing material. The scale is 500:1 so that the ranges of μm orders of magnitude are visible. The specimen shown has a composition of 2.14 wt. % nickel, 0.73 wt. % silicon, 1.52 wt. % tellurium with the rest copper, whereby the materials nickel, silicon and copper form the matrix material and tellurium is present in its undissolved phase.

The pure matrix material is depicted by the pale area (2), whilst the darker coloured areas (4) mark the added tellurium in the form of localized particles. In FIG. 1, the spatial separation of the tellurium phases or particles of the matrix material are clearly visible. The tellurium phases appear as clearly defined, mostly elongated patches, preferably with a maximum dimension of up to 15 μm in 90% of measurable cases.

This type of invented material and comparative materials underwent a wear test according to the diagram shown in FIG. 2. The test bench on which the measurements were carried out is similar to a combustion engine, equipped with original pistons, connecting rods, crankshafts and sliding bearings. During the test, the crankshaft's rotational speed is incrementally increased from 1900 rotations per minute to a maximum of 8000 rotations per minute. The latter value is equivalent to the maximum relative speed between the crankpin surface and the sliding bearing surface of 19.7 m/s. Here, the sliding bearing is subjected to a sinusoidal load in the large eye of the connecting rod, which is depicted in two parts in the form of two bearing shells. At the same time as the rotational speed, the load is increased incrementally due to the centrifugal forces that occur. In the diagram, the product of the load (in MPa) and the relative speed (in m/s) is plotted as curve 20 and scaled to the y-axis on the left hand side of the diagram. The bearing is initially lubricated with oil at a constant oil flow rate of 500 ml/mm. After a period of 250 mins, but still before the maximum load is reached, the oil flow is reduced incrementally, while the load or rotational speed is increased incrementally even further. The oil flow is also plotted on the diagram as curve 22 and scaled to the y-axis on the right-hand side of the diagram. The maximum load and sliding speed at which the bearing scuffs under these conditions is measured in each of at least three tests per bearing material under the same conditions, and is plotted as an average value in the diagram according to FIG. 3.

In FIG. 3, the measured value of the maximum load and sliding speed is shown as an indication of the seizure behaviour of four different CuNi2Si microstructure modifications. The matrix material has the same composition in all four variants: 2 wt. % Ni, 0.6 wt. % Si, rest Cu. Only material no. 12 contains an additional 0.5 wt. % tellurium and thus represents the inventive sliding bearing material.

Material 10 is a recrystallized CuSi2Ni material, cast onto steel and then subjected to the thermomechanical treatment described above. After it has undergone thermomechanical treatment, the microstructure is characterized by fine, evenly and isotropically distributed, intermetallic precipitates (“recrystallized”) on a NiSi basis within the copper matrix. In this material, an average load limit of 720 MPa m/s was measured.

Material 12 is a CuNi2Si solid bearing material with a chip-breaker that is recrystallized using thermomechanical treatment, without steel backings. Compared to all other tested CuNi2Si materials, it has the greatest load-bearing capacity without seizure at a value of 830 MPa m/s.

Material 14 is a roll cladded CuNi2Si material, which was initially rolled out as a band and then joined to a steel backing in a subsequent roll cladding process in the manner described above, and also underwent thermomechanical treatment. For this, an average load limit of 770 MPa m/s was recorded.

Material 16 is a CuNi2Si cast material that was cast onto a steel backing in the manner described above. This material did not undergo any subsequent thermomechanical treatment and is therefore not recrystallized. It therefore achieves an average load limit of just 270 MPa m/s.

The inventive sliding bearing materials therefore have an improved level of machinability compared to known sliding bearing materials without additives, as well as a surprisingly significantly reduced susceptibility to seizure. They are therefore especially suitable for use in the event of insufficient lubrication, even without solid lubricants.

1. A sliding bearing material with a matrix material, consisting of 0.5-5 wt. % nickel, 0.25-2.5 wt. % silicon, <0.1 wt. % lead, impurities that result from the metallurgical melting process, with the rest being copper, with optionally at least one hard material and optionally at least one solid lubricant, characterized by
at least an additive of tellurium.

2. A sliding bearing material according to claim 1, characterized in that the weight ratio of nickel to silicon is between 2.5 and 5.

3. A sliding bearing material according to one of the claim 1 or 2, characterized in that
the additive is dispersed within the matrix material with a total amount of between 0.01 and 2.0 wt. %.

4. A sliding bearing material according to one of the aforementioned cams, characterized in that
the additive is present in the matrix material in the form of particles, whereby 90% of the measurable particles have a maximum dimension of 30 μm, preferably of 15 μm.

5. A sliding bearing material according to one of the aforementioned claims, characterized in that
below the limit of 800 MPa m/s, preferably below 850 MPa m/s, no adhesive wearing occurs.

6. A sliding bearing material according to one of the aforementioned claims, characterized by
at least one hard material selected from a group consisting of silicides, oxides, carbides and nitrides, in particular AlN, Al₂O₃, SO₂, TiO₂, ZrO₂, Mo₂C, MoSi₂, SiC, B₄C, Si₃N₄ and c-BN.

7. A sliding bearing material according to one of the aforementioned claims, characterized by
at least one solid lubricant selected from a group consisting of h-BN and graphite.

8. A sliding bearing composite material with a backing layer, a bearing metal layer and a sliding layer applied to said bearing metal layer, characterized in that
the bearing metal layer consists of a sliding bearing material according to one of the patent claims 1 to 7.

9. A sliding bearing composite material according to claim 8, characterized in that
the bearing metal layer is a sinter layer.

10. A sliding bearing composite material according to claim 8, characterized in that
there is, if necessary via an intermediate layer, a roll cladding connection between the bearing metal layer and the backing layer.

11. A sliding bearing composite material according to claim 8, characterized in that
the bearing metal layer is a cast layer.

12. A sliding element or sliding bearing with a sliding bearing material according to one of the patent claims 1 to 7.

13. A sliding element or sliding bearing made from a sliding bearing composite material according to one of the patent claims 8 to 10.
